(19) United States
(12) Patent Application Publication
(10) Pub. No.: US 2024/0173585 A1
(43) Pub. Date: May 30, 2024

(54) INJECTION ASSEMBLY FOR CONTAINERS

(71) Applicant: Carrier Corporation, Palm Beach Gardens, FL (US)

(72) Inventors: Anthony Cilluffo, Ashland, MA (US); John Kliem, Wayland, MA (US)

(21) Appl. No.: 18/516,947

(22) Filed: Nov. 22, 2023

Related U.S. Application Data
(60) Provisional application No. 63/385,229, filed on Nov. 29, 2022.

(51) Int. Cl. A62C 35/02; A62C 35/68

(52) U.S. Cl. CPC A62C 35/023; A62C 35/68

(57) ABSTRACT

An injection assembly having an injection adapter for injecting pressurized gas in containers is disclosed. The injection adapter comprises a body adapted to be coaxially coupled to an opening of a container. The body comprises a discharge passage adapted to allow a flow of fire suppression agent from the container. Further, the body comprises at least one injecting passage adapted to be in fluid communication with an ullage space of the container. The at least one injecting passage is adapted to supply pressurized gas from a canister to an ullage space within the container.

### FIELD OF THE INVENTION

The disclosure relates to fire suppression systems and more particularly, to an injection assembly having an injection adapter for delivering pressurized gas in containers of a fire suppression system.

### BACKGROUND

Fire suppression systems are usually employed for discharging fire suppressing agents towards a fire. The fire suppression systems are provided with a storage container containing a fire suppressing agent which is discharged out of discharge nozzles in an area to extinguish the fire. With the advancement in technology, the fire suppression systems are now deployed with a separate storage container containing a pressurized gas which is to be used for propelling the fire suppressing agent from the storage container at a higher pressure towards the discharged nozzles. In such systems, a propellant pressure from the separate storage container is introduced, at a controlled rate, into a vapor space of the storage container containing the fire suppressing agent. This propellant pressure acts to propel the fire suppressing agent through a pipe system at the higher pressure.

Currently, welded cylinders are employed for storing the fire suppressing agents. In such welded cylinders, welded bosses are provided to facilitate a connection between the welded cylinder and the separate storage container containing the pressurized gas to be used as a booster for propelling the fire suppressing agent. However, in some fire suppression systems, containers, such as seamless cylinders are usually employed for storing the fire suppressing agents. Such containers lacks any additional provision to facilitate connection with the separate storage container for receiving the pressurized gas. Therefore, implementation of the separate storage container for propelling the fire suppressing agent, at the higher flow rate, contained in the containers is cumbersome and cost-intensive.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

In one or more embodiments of the disclosure, an injection adapter for injecting pressurized gas in containers is disclosed. The injection adapter comprises a body adapted to be coaxially coupled to an opening of a container. The body comprises a discharge passage adapted to allow a flow of fire suppression agent from the container. Further, the body comprises at least one injecting passage adapted to be in fluid communication with an ullage space of the container. The at least one injecting passage is adapted to supply pressurized gas from a canister to an ullage space within the container.

In one or more embodiments of the disclosure, the body comprises an outer surface and an inner surface distal to the outer surface. The inner surface defines the discharge passage adapted to be in fluid communication with a discharge valve assembly and a siphon tube inserted within the container.

In one or more embodiments of the disclosure, the at least one injecting passage is defined between the outer surface and the inner surface of the body.

In one or more embodiments of the disclosure, the body comprises a first engaging end adapted to be coaxially coupled with the discharge valve assembly. Further, the body comprises a second engaging end coaxial with respect to the first engaging end and is adapted to be coaxially coupled with the siphon tube. The first engaging end and the second engaging end define an outlet and an inlet, respectively, of the discharge passage.

In one or more embodiments of the disclosure, the second engaging end is adapted to be externally fastened to a neck portion of the container. The neck portion defines the opening, of the container, extending along a length of the neck portion.

In one or more embodiments of the disclosure, the second engaging end is adapted to be coaxially positioned within the neck portion of the container.

In one or more embodiments of the disclosure, the second engaging end is adapted to be internally fastened to the siphon tube.

In one or more embodiments of the disclosure, an injection inlet is formed on the outer surface of the body of the injection adapter, and an injection outlet is formed on a circumferential wall, of the body, surrounding the outlet of the discharge passage. The at least one injecting passage extends between the injection inlet and the injection outlet.

In one or more embodiments of the disclosure, the body is adapted to be coupled to at least one check valve having at least one connecting passage adapted to be aligned with the at least one injecting passage of the body to facilitate a fluid communication between the injection adapter and the at least one check valve adapter.

In another embodiment of the disclosure, an injection assembly for containers of a fire suppression system is disclosed. The injection assembly comprises an injection adapter having a body adapted to be coaxially coupled to an opening of a container. The body comprises a discharge passage and at least one injecting passage adapted to be in fluid communication with an ullage space of the container. The discharge passage is adapted to receive a flow of fire suppression agent from the container. Further, the injection assembly comprises at least one check valve adapter coupled to the body of the injection adapter. The at least one check valve adapter comprises at least one connecting passage adapted to be aligned with the at least one injecting passage of the body to facilitate a fluid communication between the injection adapter and the at least one check valve adapter. The at one connecting passage allows a flow of pressurized gas within the ullage space of the container through the at least one injecting passage of the injection adapter.

In one or more embodiments of the disclosure, the body comprises an outer surface and an inner surface distal to the outer surface, the inner surface defines the discharge passage adapted to be in fluid communication with a discharge valve assembly and a siphon tube inserted within the container.

In one or more embodiments of the disclosure, the at least one injecting passage is defined between the outer surface and the inner surface of the body.

In one or more embodiments of the disclosure, the body comprises a first engaging end adapted to be coaxially coupled with the discharge valve assembly. Further, the body comprises a second engaging end coaxial with respect to the first engaging end and is adapted to be coaxially coupled with the siphon tube. The first engaging end and the second engaging end define an outlet and an inlet, respectively, of the discharge passage.

In one or more embodiments of the disclosure, the second engaging end is adapted to be externally fastened to a neck portion of the container. The neck portion defines the opening, of the container, extending along a length of the neck portion.

In one or more embodiments of the disclosure, the second engaging end is adapted to be coaxially positioned within the neck portion of the container.

In one or more embodiments of the disclosure, the second engaging end is adapted to be internally fastened to the siphon tube.

In one or more embodiments of the disclosure, an injection inlet is formed on the outer surface of the body of the injection adapter, and an injection outlet is formed on a circumferential wall, of the body, surrounding the outlet of the discharge passage. The at least one injecting passage extends between the injection inlet and the injection outlet.

In one or more embodiments of the disclosure, the at least one connecting passage comprises an inlet and an outlet adapted to be aligned with an injection inlet of the at least one injecting passage.

In one or more embodiments of the disclosure, at least one orifice plate is disposed between the injection inlet and the outlet of the at least one connecting passage. Further, at least one check valve is coupled to the inlet of the at least one connecting passage.

In yet another embodiment of the disclosure, a fire suppression system is disclosed. The fire suppression system comprises at least one canister containing a pressurized gas. Further, the fire suppression system comprises at least one storage container in fluid communication with the at least one canister and contains a fire suppression agent. The fire suppression system comprises an injection assembly coupled to an opening of the at least one storage container. The injection assembly comprises an injection adapter having a discharge passage in fluid communication with the at least one storage container and at least one injecting passage in fluid communication with at least one canister and the at least one storage container. The fire suppression system comprises a discharge valve assembly coaxially coupled to an outlet of the discharge passage and adapted to discharge the fire suppression agent from the at least one storage container. Further, the first suppression system comprises a siphon tube having a first end coaxially coupled to an inlet of the discharge passage and a second end positioned within the at least one storage container. The discharge passage allows a flow of the fire suppression agent from the siphon tube to the discharge valve assembly, and the at least one injecting passage supplies the pressurized gas from the at least one canister to an ullage space within the at least one storage container.

To further clarify the advantages and features of the methods, systems, and apparatuses/devices, a more particular description of the methods, systems, and apparatuses/devices will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an exemplary schematic view of a fire suppression system, according to one or more embodiments of the disclosure;

FIG. 2 illustrates an isometric view of an injection assembly mounted on a container of the fire suppression system, according to one or more embodiments of the disclosure;

FIGS. 3a and 3b illustrate planar views depicting the container with the injection assembly, according to one or more embodiments of the disclosure;

FIG. 4 illustrates an enlarged sectional view of the injection assembly and a valve assembly mounted on the container, according to one or more embodiments of the disclosure; and

FIG. 5 illustrates a sectional view of the injection assembly, according to one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system and device, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the disclosure will be described below in detail with reference to the accompanying drawings.

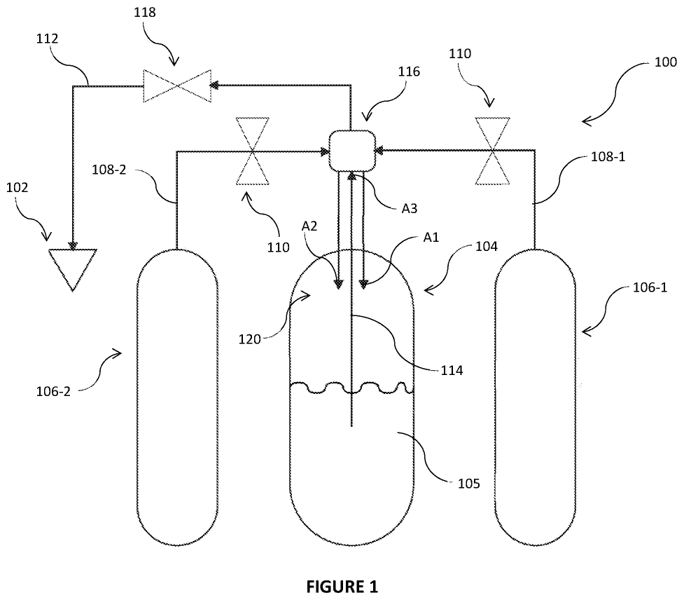

FIG. 1 illustrates an exemplary schematic view of a fire suppression system 100, according to one or more embodiments of the disclosure. The fire suppression system 100 may be employed to detect parameters, such as smoke, temperature, or other warning signs, associated with flammable elements, such as gases or any other flammable object present in a space and subsequently, extinguish flames arising from the flammable elements or prevent such flammable element from burning in a space based on the detection. In one embodiment, the fire suppression system 100 may be automatically operated to extinguish the flames or prevent the flammable elements from burning based on the detection of parameters associated with the flammable element. In another embodiment, the fire suppression system 100 may be manually operated from a remote location, such as a remote manual pull station.

Referring to FIG. 1, in the illustrated embodiment, the fire suppression system 100 may include, but is not limited to, at least one nozzle 102, at least one storage container 104 in fluid communication with the at least one nozzle 102, and at least one canister 106 in fluid communication with the at least one storage container 104.

In one or more embodiments, the at least one canister 106 may be adapted to store a pressurized gas which is to be supplied to the at least one storage container 104. In one embodiment, the pressurized gas may be embodied as one of nitrogen, argon, carbon dioxide, or a mixture thereof. In another embodiment, the pressurized gas may be embodied as any inert gas known in the art, without departing from the scope of the disclosure.

Referring to FIG. 1, in the illustrated embodiment, the fire suppression system 100 may include a first canister 106-1 and a second canister 106-2 to store the pressurized gas which is to be supplied to the at least one storage container 104. However, it should not be construed as limiting, and the fire suppression system 100 may include multiple canisters containing the pressurized gas, without departing from the scope of the disclosure.

Further, the fire suppression system 100 may include a piping system to fluidly connect the at least one storage container 104 with each of the first canister 106-1 and the second canister 106-2. Referring to FIG. 1, in the illustrated embodiment, the piping system may include, but is not limited to, a first injection conduit 108-1 to fluidly connect the first canister 106-1 with the at least one storage container 104 and a second injection conduit 108-2 to fluidly connect the second canister 106-2 with the at least one storage container 104. At least one control valve 110 may be positioned in each of the first injection conduit 108-1 and the second injection conduit 108-2 to control a flow of pressurized gas from each of the first canister 106-1 and the second canister 106-2 to the at least one storage container 104.

The at least one storage container 104 may be adapted to store a fire suppression agent 105. In one or more embodiments, the fire suppression agent 105 may be one of FK-5-1-12, 1,1,1,2,2,4,5,5,5-nonafluoro-4-(trifluoromethyl)-3-pentanone (CF3CF2C(═O)CF(CF3)2), CAS 756-13-6; HFC-227ea, 1,1,1,2,3,3,3-heptaflurorporpane (CF3CHFCF3), CAS 431-89-0; HFC-125, 1,1,1,2,2-pentafluoroethane, CAS 354-33-6; HFC-236fa, and 1,1,1,2,2,2-hexafluoropropane (CF3CHFCF2H), CAS 690-39-1. It should be appreciated by a person skilled in the art that different types of fire suppression agents as explained in the disclosure should not be construed as limiting, and other types of fire suppression agent can also be employed in the fire suppression system 100, without departing from the scope of the disclosure.

Referring to FIG. 1, in the illustrated embodiment, the fire suppression system 100 may include a single storage container, i.e., the storage container 104, to store the fire suppression agent 105 which is to be supplied to the at least one nozzle 102. However, it should not be construed as limiting, and the fire suppression system 100 may include multiple storage containers containing the fire suppression agent 105, without departing from the scope of the disclosure.

In one or more embodiments, the at least one storage container 104 may be embodied as a seamless cylinder, a hot-forged cylinder, a cold-forged cylinder, and a tube-forged cylinder. The term ‘seamless cylinder’ herein referred to a cylindrical container having a body machined from seamless tubing to provide consistent wall thickness, size, and capacity. It should be appreciated by a person skilled in the art that different types of storage containers as explained in the disclosure should not be construed as limiting, and other types of storage containers can also be employed in the fire suppression system 100, without departing from the scope of the disclosure.

The at least one storage container 104 may interchangeably be referred to as the container 104, without departing from the scope of the disclosure. The container 104 may be in fluid communication with the at least one nozzle 102 to supply the fire suppression agent 105. In the illustrated embodiment, a discharge conduit 112 of the piping system may be configured to supply the fire suppression agent 105 to the at least one nozzle 102.

Further, the fire suppression system 100 may include, but is not limited to, a siphon tube 114, an injection assembly 116, and a discharge valve assembly 118. The siphon tube 114 may include a first end coupled to the injection assembly 116 and a second end positioned within the container 104. In one or more embodiments, the second end may be dipped in the fire suppression agent 105 stored within the container 104. During operation of the fire suppression system 100, the siphon tube 114 may facilitate the flow of the fire suppression agent 105 from the container 104, when the pressurized gas is supplied to an ullage space 120 and the discharge valve assembly 118 is operated to allow the flow of the fire suppression agent 105 to the at least one nozzle 102.

In one or more embodiments, the injection assembly 116 may be in fluid communication with the container 104, the first canister 106-1 via the first injection conduit 108-1, and the second canister 106-2 via the second injection conduit 108-2. The injection assembly 116 may be adapted to facilitate injection of the pressurized gas from canisters 106-1, 106-2 to the ullage space 120 of the container 104. Referring to FIG. 1, arrows A1 and A2 indicate the injection of the pressurized gas in the ullage space 120 through the injection assembly 116. Further, the injection assembly 116 may be in fluid communication with the discharge valve assembly 118 to facilitate supply of the fire suppression agent 105 through the siphon tube 114 from the container 104 to the discharge valve assembly 118. Referring to FIG. 1, arrow A3 indicates the flow of the fire suppression agent 105 to the injection assembly 116 through the siphon tube 114.

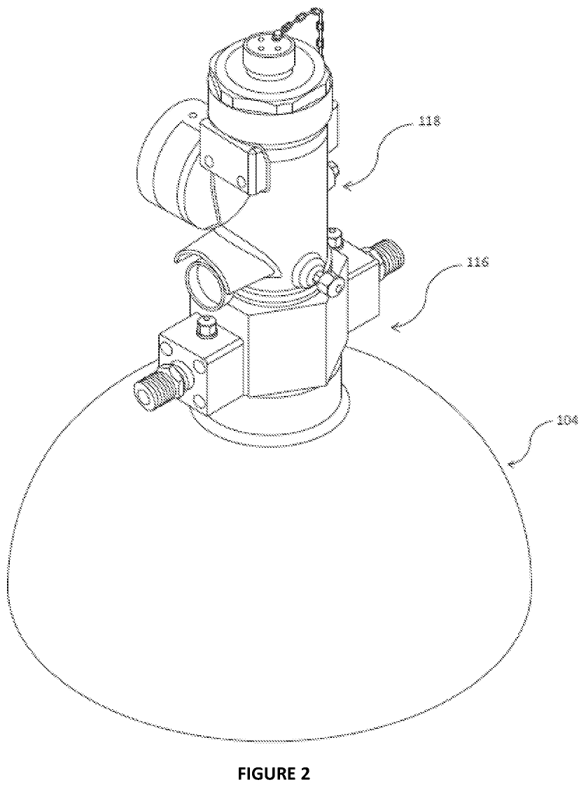

Constructional and operational details of the injection assembly 116 are explained in detail in the description of FIGS. 2, 3a-3b, 4, and 5 of the disclosure.

The fire suppression system 100 as depicted in FIG. 1 is exemplary and should not limit the scope of the disclosure. The functionality of the fire suppression system 100 described herein is also exemplary. A person of ordinary skill in the art will appreciate that the fire suppression system 100 may additionally include other components and capabilities not described herein.

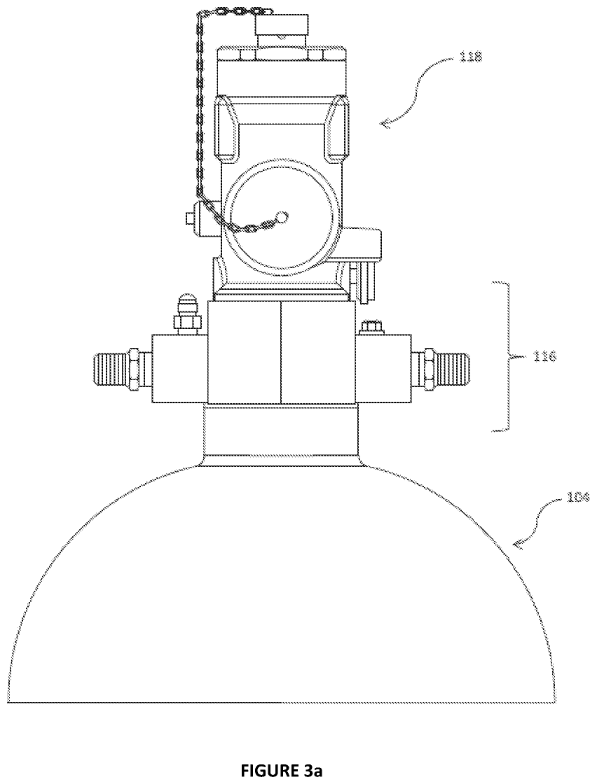

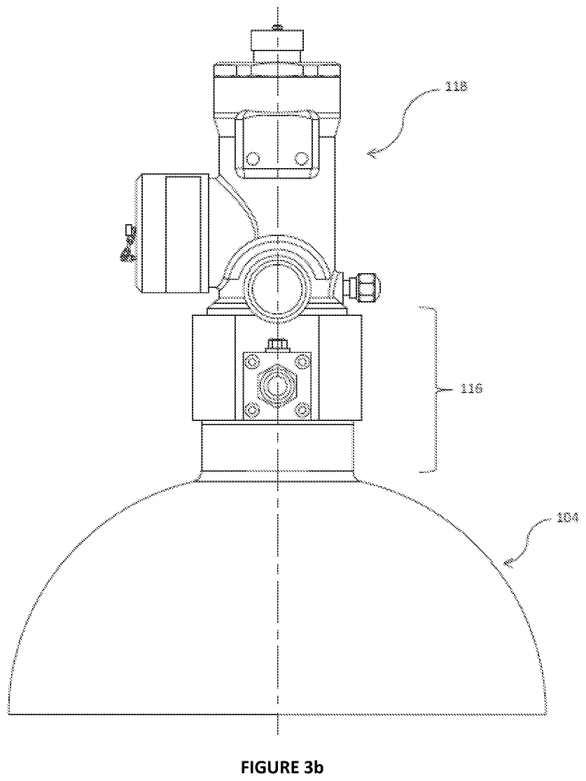

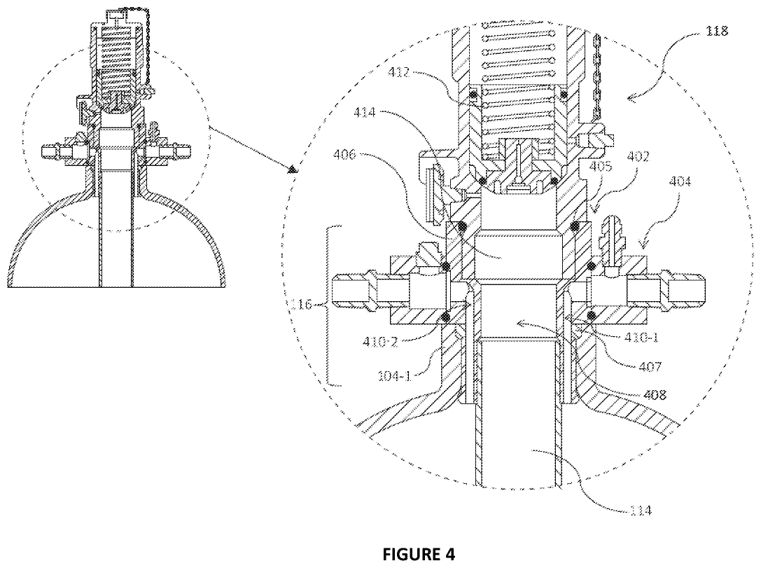

FIG. 2 illustrates an isometric view of the injection assembly 116 mounted on the container 104 of the fire suppression system 100, according to one or more embodiments of the disclosure. FIGS. 3a and 3b illustrate planar views depicting the container 104 with the injection assembly 116, according to one or more embodiments of the disclosure. FIG. 4 illustrates an enlarged sectional view of the injection assembly 116 and the discharge valve assembly 118 mounted on the container 104, according to one or more embodiments of the disclosure.

In one or more embodiments, the injection assembly 116 may be coupled to the discharge valve assembly 118 and the siphon tube 114 which is inserted within the container 104. The injection assembly 116 may facilitate the flow of pressurized gas to the ullage space 120 of the container 104 and the flow of fire suppression agent 105 to the discharge valve assembly 118 from the container 104. Referring to FIGS. 2, 3a-3b, and 4, in the illustrated embodiment, the injection assembly 116 may include, but is not limited to, an injection adapter 402 and at least one check valve adapter 404.

The injection adapter 402 may include a body 406 adapted to be coaxially coupled to the container 104. In the illustrated embodiment, the body 406 may be coaxially coupled to an opening of the container 104. A neck portion 104-1 of the container 104 defines the opening extending along a length of the neck portion 104-1. As mentioned earlier, the injection adapter 402 may facilitate a flow of the fire suppressing agent 105 from the container 104 and injection of the pressurized gas in the ullage space 120 of the container 104 from a single opening, i.e., the opening defined by the neck portion 104-1.

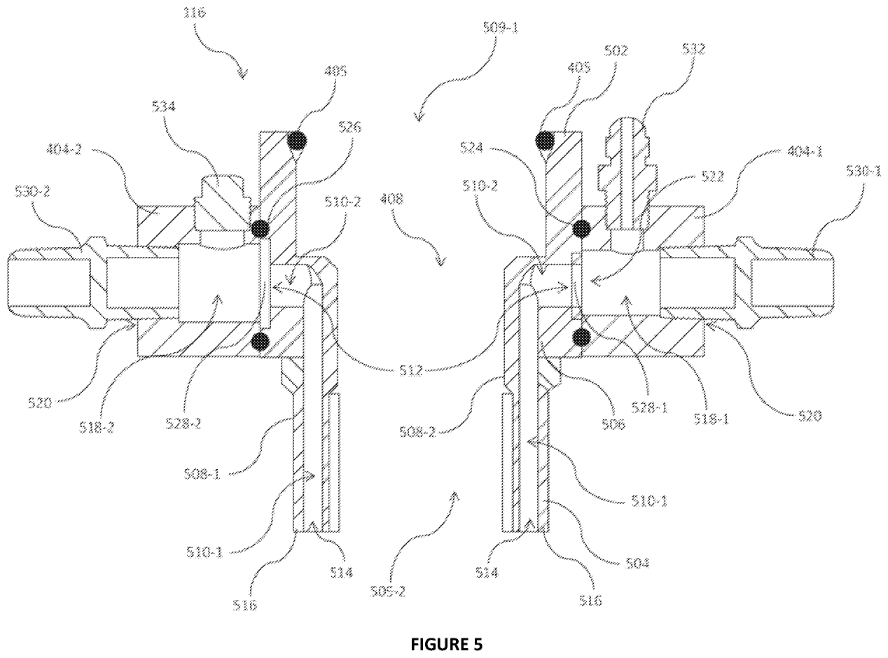

FIG. 5 illustrates a sectional view of the injection assembly 116, according to one or more embodiments of the disclosure. Referring to FIGS. 4 and 5, in the illustrated embodiment, the body 406 may include a first engaging end 502, an intermediate portion 506, and a second engaging end 504 coaxial with respect to the first engaging end 502 and the intermediate portion 506. The first engaging end 502 may be adapted to be coaxially coupled with the discharge valve assembly 118. In one or more embodiments, the first engaging end 502 may include internal threads adapted to be engaged with external threads of the discharge valve assembly 118.

The second engaging end 504 is adapted to be externally fastened to the neck portion 104-1 of the container 104. The second engaging end 504 may be adapted to be coaxially positioned within the neck portion 104-1 of the container 104. In one or more embodiments, the second engaging end 504 may include external threads adapted to be engaged with internal threads of the neck portion 104-1. Further, the second engaging end 504 may be adapted to be coaxially coupled with the siphon tube 114. The second engaging end 504 may be adapted to be internally fastened to the siphon tube 114. In one or more embodiments, the second engaging end 504 may include internal threads adapted to be engaged with external threads of the siphon tube 114.

In the illustrated embodiment, a sealing ring 405, such as O-ring, may be disposed between the first engaging end 502 and the discharge valve assembly 118 to prevent leakage of the fire suppression agent 105. Similarly, a sealing ring 407 may be disposed between the second engaging end 504 and the siphon tube 114 to prevent leakage of the fire suppression agent 105.

The intermediate portion 506 of the body 406 may be disposed between the first engaging end 502 and the second engaging end 504 of the body 406. The intermediate portion 506 may be adapted to be coupled to the at least one check valve adapter 404. Constructional and operational details of the at least one check valve adapter 404 are explained in detail in the subsequent sections of the disclosure.

Further, the body 402 may include, but is not limited to, a discharge passage 408 and at least one injecting passage 410 adapted to be in fluid communication with the ullage space 120 of the container 104. Referring to FIGS. 4 and 5, the body 406 may include an outer surface 508-1 and an inner surface 508-2 distal to the outer surface 508-1. The inner surface 508-2 may define the discharge passage 408 adapted to be in fluid communication with the discharge valve assembly 118 and the siphon tube 114 inserted within the container 104.

The discharge passage 408 may be adapted to receive a flow of fire suppression agent 105 from the container 104. The first engaging end 502 and the second engaging end 504 may define an outlet 509-1 and an inlet 509-2, respectively, of the discharge passage 408. The discharge passage 408 may receive the flow of fire suppression agent 105 from the siphon tube 114 through the inlet 509-2, and subsequently, the outlet 508-1 of the discharge passage 408 allows the flow of fire suppression agent 105 towards the discharge valve assembly 118. In the illustrated embodiment, referring to FIG. 5, the discharge passage 408 may be coaxial with respect to the siphon tube 114 coupled to the second engaging end 504 and the discharge valve assembly 118 coupled to the first engaging end 502.

In one or more embodiments, the discharge valve assembly 118 may include, but is not limited to, an outlet (not shown), a resilient member 412 such as a spring, and a piston assembly 414. The piston assembly 414 may be adapted to be actuated by the flow of the fire suppression agent 105 received from the discharge passage 408 of the injection adapter 402. The piston assembly 414 may be actuated to allow the flow of the fire suppression agent 105 to be discharged through the outlet, of the discharge valve assembly 118, towards the at least one nozzle 102 of the fire suppression system 100. The discharge valve assembly 118 as depicted in the FIGS. 2, 3a-3b, and 4 is exemplary and should not limit the scope of the disclosure. The functionality of the discharge valve assembly 118 described herein is also exemplary. A person of ordinary skill in the art will appreciate that the discharge valve assembly 118 may additionally include other components and capabilities not described herein.

As mentioned earlier, the injection adapter 402 may also include the at least one injecting passage 410 to allow the flow of pressurized gas from the at least one canister 106-1, 106-2 to the ullage space 120 of the container 104. In the illustrated embodiment, the body 406 of the injection adapter 402 may include a pair of injecting passages 410-1, 410-2. Although, the injection assembly 116 is explained with respect to the injection adapter 402 having two injecting passages 410-1, 410-2. It should not be construed as limiting, and the injection adapter 402 may include one or more injecting passages to be connected to one or more canisters 106 containing the pressurized gas.

In the illustrated embodiment, each of the pair of injecting passages 410-1, 410-2 may be defined between the outer surface 508-1 and the inner surface 508-2 of the body 406. Each of the pair of injecting passages 410-1, 410-2 may include a first portion 510-1 extending parallel to the discharge passage 408 of the body 406 and a second portion 510-2 extending laterally from the first portion 510-1 in a direction towards the outer surface 508-1 of the body 406. The first portion 510-1 and the second portion 510-2 may be in fluid communication with each other. In the illustrated embodiment, the first portion 510-1 may be orthogonally formed with respect to the second portion 510-2.

Referring to FIG. 5, an injection inlet 512 may be formed on the outer surface 508-1 of the body 406. Further, an injection outlet 514 may be formed on a circumferential wall 516, of the body 406, surrounding the outlet 509-2 of the discharge passage 408. Each of the pair of injecting passages 410-1, 410-2 may extend between the injection inlet 512 and the injection outlet 514. Referring to FIG. 4, the injection adapter 402 may be coupled to the neck portion 104-1 of the container 104 in a manner that the injection outlet 514 of each of the pair of injecting passages 410-1, 410-2 is in fluid communication with the ullage space 120 of the container 104.

As mentioned earlier, the injection assembly 116 may include the at least one check valve adapter 404 coupled to the body 406 of the injection adapter 402. In the illustrated embodiment, the injection assembly 116 may include a first check valve adapter 404-1 and a second check valve adapter 404-2. Although, the injection assembly 116 is explained with respect to the injection adapter 402 coupled to two check valve adapters 404-1, 404-2. It should not be construed as limiting, and the injection assembly 116 may include one or more check valve adapters. In one or more embodiments, a number of the check valve adapters 404 to be deployed for the injection assembly 116 may vary based on a number of the injecting passages 410 provided within the injection adapter 402 of the injection assembly 116.

Referring to FIG. 5, in the illustrated embodiment, the first check valve adapter 404-1 may be coupled to the outer surface 508-1 of the injection adapter 402 in a manner that an injecting passage, such as the injecting passage 410-1, may facilitate a fluid communication between the first check valve adapter 404-1 and the ullage space 120 of the container 104. Further, the second check valve adapter 404-2 may be coupled to the outer surface 508-1 of the injection adapter 402 in a manner that an injecting passage, such as the injecting passage 410-2, may facilitate a fluid communication between the second check valve adapter 404-1 and the ullage space 120 of the container 104. In one or more embodiments, the first check valve adapter 404-1 and the second check valve adapter 404-2 may be coupled to the outer surface 508-1 via fasteners, such as screws.

In one or more embodiments, each of the check valve adapters 404-1, 404-2 may include at least one connecting passage 518 adapted to be aligned with the at least one injecting passage, such as the injecting passages 410-1, 410-2, of the body 406 to define a fluid communication between the injection adapter 402 and each of the check valve adapters 404-1, 404-2. In the illustrated embodiment, referring to FIG. 5, the first check valve adapter 404-1 and the second check valve adapter 404-2 may include a first connecting passage 518-1 and a second connecting passage 518-2, respectively.

The first connecting passage 518-1 and the second connecting passage 518-2 may collectively be referred to as the connecting passages 518-1, 518-2, without departing from the scope of the disclosure. Each of the connecting passages 518-1, 518-2 may be adapted to allow the flow of pressurized gas within the ullage space 120 of the container 104 through one of the injecting passages 410-1, 410-2 of the injection adapter 402. Each of the connecting passages 518-1, 518-2 may include an inlet 520 and an outlet 522 adapted to be aligned with the injection inlet 512 of one of the injecting passages 410-1, 410-2. In the illustrated embodiment, the outlet 522 of the first connecting passage 518-1 may be aligned with the injection inlet 512 of the injection passage 410-1. Similarly, the outlet 522 of the second connecting passage 518-2 may be aligned with the injection inlet 512 of the injection passage 410-2.

In the illustrated embodiment, the first check valve adapter 404-1 may be coupled to the injection adapter in a manner that the first connecting passage 518-1 allows the flow of pressurized gas, from the first canister 106-1, within the ullage space 120 through the injecting passage 410-1 of the injection adapter 402. Similarly, the second check valve adapter 404-2 may be coupled to the injection adapter in a manner that the second connecting passage 518-2 allows the flow of pressurized gas, from the second canister 106-2, within the ullage space 120 through the injecting passage 410-2 of the injection adapter 402. In one or more embodiments, a sealing ring 524, such as an O-ring, may be disposed between the first check valve adapter 404-1 and the outer surface 508-1 of the injection adapter 402 to prevent leakage of the pressurized gas therethrough. Similarly, a sealing ring 526, such as an O-ring, may be disposed between the second check valve adapter 404-2 and the outer surface 508-1 of the injection adapter 402 to prevent leakage of the pressurized gas.

Further, the injection assembly 116 may include, but is not limited to, at least one orifice plate 528 disposed between the injection inlet 512 and the outlet 522 of the at least one connecting passage 518-1, 518-2. In the illustrated embodiment, an orifice plate 528-1 may be disposed between the injection inlet 512 of the injecting passage 410-1 and the outlet 522 of the first connecting passage 518-1. Similarly, an orifice plate 528-2 may be disposed between the injection inlet 512 of the injecting passage 410-2 and the outlet 522 of the second connecting passage 518-2. Each of the orifice plates 528-1, 528-2 may facilitate metering of the flow of pressurized gas from the at least one canister, such as 106-1, 106-2, to the container 104. A person of ordinary skill in the art will appreciate that orifice plates with different operational and dimensional characteristics can be employed in the injection assembly 116, without departing from the scope of the disclosure.

The injection assembly 116 may include, but is not limited to, at least one check valve 530 coupled to the inlet 520 of the at least one connecting passage 518-1, 518-2. In the illustrated embodiment, a check valve 530-1 may be fastened to the inlet 520 of the first connecting passage 518-1. The check valve 530-1 may include external threads adapted to be engaged with internal threads of the first check valve adaptor 404-1. Referring to FIG. 1 and FIG. 5, one end of the check valve 530-1 may be fluidly coupled to the first canister 106-1 via the first injection conduit 108-1. The check valve 530-1 may allow the pressurized gas to flow from the first canister 106-1 to the first check valve adapter 404-1 and subsequently, to the injecting passage 410-1.

Similarly, a check valve 530-2 may be fastened to the inlet 520 of the second connecting passage 518-2. The check valve 530-2 may include external threads adapted to be engaged with internal threads of the second check valve adaptor 404-2. Referring to FIG. 1 and FIG. 5, one end of the check valve 530-2 may be fluidly coupled to the second canister 106-2 via the second injection conduit 108-2. The check valve 530-2 may allow the pressurized gas to flow from the second canister 106-2 to the second check valve adapter 404-2 and subsequently, to the injecting passage 410-2. Further, in one or more embodiments, a flare fitting 532 may be coupled to the check valve 530-1 and a plug 534 may be coupled be coupled to the check valve 530-2. In one or more embodiments, the flare fitting 532 may be connected to an actuator disposed at a top of the discharge valve assembly 118.

In an exemplary embodiment, during operation, the pressurized gas may be supplied from the first canister 106-1 and the second canister 106-2 to the first connecting passage 518-1 of the first check valve adapter 404-1 and the second connecting passage 518-2 of the second check valve adapter 404-2. Subsequently, the injecting passage 410-1 may receive the pressurized gas through the first connecting passage 518-1 and, the injecting passage 410-2 may receive the pressurized gas through the second connecting passage 518-2. Thereafter, the pressurized gas may be injected in the ullage space 120 from the injection outlet 514 of each of the injection passages 410-1, 410-2. Upon injecting the pressurized gas, the fire suppression agent 105 may rise within the siphon tube 114 towards the inlet 509-2 of the discharge passage 408 of the injection adapter 402. Subsequently, the fire suppression agent 105 may enter within the discharge passage 408. Once the canisters 106-1, 106-2 activate, a pressure may be delivered to the flare fitting 532. Subsequently, the pressure through the flare fitting 532 may be delivered to a pressure operated control head (not shown) which allows the piston assembly 414 to move upward and allowing the flow of the fire suppression agent 105 towards the at least one nozzle 102 of the fire suppression system 100.

As would be gathered, the disclosure offers the injection assembly 116 for injecting pressurized gas within the container 104 of the fire suppression system 100. As explained earlier, the injection assembly 116 includes the injection adapter 402 which can be coupled to the opening of the container 104. The injection adapter 402 includes the discharge passage to allow the flow of the fire suppressing agent 105 from the container 104 and the injecting passages to allow injection of the pressurized gas in the ullage space of the container 104. Therefore, implementation of the injection adapter 402 enables the functionality of discharging the fire suppressing agent 105 and injecting the pressurized gas in the ullage space through a single opening, i.e., the opening defined by the neck portion, of the container 104. Therefore, the injection assembly 116 of the disclosure is compact, efficient, durable, flexible in implementation, cost-effective, light-weight, and convenient.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. An injection adapter for injecting pressurized gas in containers, the injection adapter comprising:
a body adapted to be coaxially coupled to an opening of a container, the body comprising:
a discharge passage adapted to allow a flow of fire suppression agent from the container; and
at least one injecting passage adapted to be in fluid communication with an ullage space of the container,
wherein the at least one injecting passage is adapted to supply pressurized gas from a canister to an ullage space within the container.

2. The injection adapter according to claim 1, wherein the body comprises an outer surface and an inner surface distal to the outer surface, the inner surface defines the discharge passage adapted to be in fluid communication with a discharge valve assembly and a siphon tube inserted within the container.

3. The injection adapter according to claim 2, wherein the at least one injecting passage is defined between the outer surface and the inner surface of the body.

4. The injection adapter according to claim 1, wherein the body comprises:
a first engaging end adapted to be coaxially coupled with the discharge valve assembly; and
a second engaging end coaxial with respect to the first engaging end and adapted to be coaxially coupled with the siphon tube,
wherein the first engaging end and the second engaging end define an outlet and an inlet, respectively, of the discharge passage.

5. The injection adapter according to claim 4, wherein the second engaging end is adapted to be externally fastened to a neck portion of the container, wherein the neck portion defines the opening, of the container, extending along a length of the neck portion.

6. The injection adapter according to claim 5, wherein the second engaging end is adapted to be coaxially positioned within the neck portion of the container.

7. The injection adapter according to claim 4, wherein the second engaging end is adapted to be internally fastened to the siphon tube.

8. The injection adapter according to claim 2, wherein an injection inlet is formed on the outer surface of the body of the injection adapter and an injection outlet is formed on a circumferential wall, of the body, surrounding the outlet of the discharge passage, wherein the at least one injecting passage extends between the injection inlet and the injection outlet.

9. The injection adapter according to claim, wherein the body is adapted to be coupled to at least one check valve having at least one connecting passage adapted to be aligned with the at least one injecting passage of the body to facilitate a fluid communication between the injection adapter and the at least one check valve adapter.

10. An injection assembly for containers of a fire suppression system, the injection assembly comprising:
an injection adapter having a body adapted to be coaxially coupled to an opening of a container, the body comprising a discharge passage and at least one injecting passage adapted to be in fluid communication with an ullage space of the container, wherein the discharge passage is adapted to receive a flow of fire suppression agent from the container; and
at least one check valve adapter coupled to the body of the injection adapter, the at least one check valve adapter comprising at least one connecting passage adapted to be aligned with the at least one injecting passage of the body to facilitate a fluid communication between the injection adapter and the at least one check valve adapter,
wherein the at one connecting passage allows a flow of pressurized gas within the ullage space of the container through the at least one injecting passage of the injection adapter.

11. The injection assembly according to claim 10, wherein the body comprises an outer surface and an inner surface distal to the outer surface, the inner surface defines the discharge passage adapted to be in fluid communication with a discharge valve assembly and a siphon tube inserted within the container.

12. The injection assembly according to claim 11, wherein the at least one injecting passage is defined between the outer surface and the inner surface of the body.

13. The injection assembly according to claim 10, wherein the body comprises:
a first engaging end adapted to be coaxially coupled with the discharge valve assembly; and
a second engaging end coaxial with respect to the first engaging end and adapted to be coaxially coupled with the siphon tube,
wherein the first engaging end and the second engaging end define an outlet and an inlet, respectively, of the discharge passage.

14. The injection assembly according to claim 13, wherein the second engaging end is adapted to be externally fastened to a neck portion of the container, wherein the neck portion defines the opening, of the container, extending along a length of the neck portion.

15. The injection assembly according to claim 14, wherein the second engaging end is adapted to be coaxially positioned within the neck portion of the container.

16. The injection assembly according to claim 13, wherein the second engaging end is adapted to be internally fastened to the siphon tube.

17. The injection assembly according to claim 11, wherein an injection inlet is formed on the outer surface of the body of the injection adapter and an injection outlet is formed on a circumferential wall, of the body, surrounding the outlet of the discharge passage, wherein the at least one injecting passage extends between the injection inlet and the injection outlet.

18. The injection assembly according to claim, wherein the at least one connecting passage comprises an inlet and an outlet adapted to be aligned with an injection inlet of the at least one injecting passage.

19. The injection assembly according to claim 18 further comprising:
at least one orifice plate disposed between the injection inlet and the outlet of the at least one connecting passage; and
at least one check valve coupled to the inlet of the at least one connecting passage.

20. A fire suppression system comprising:
at least one canister containing a pressurized gas;
at least one storage container in fluid communication with the at least one canister and containing a fire suppression agent;
an injection assembly coupled to an opening of the at least one storage container, the injection assembly comprising an injection adapter having a discharge passage in fluid communication with the at least one storage container and at least one injecting passage in fluid communication with at least one canister and the at least one storage container;
a discharge valve assembly coaxially coupled to an outlet of the discharge passage and adapted to discharge the fire suppression agent from the at least one storage container; and
a siphon tube having a first end coaxially coupled to an inlet of the discharge passage and a second end positioned within the at least one storage container,
wherein the discharge passage allows a flow of the fire suppression agent from the siphon tube to the discharge valve assembly, and the at least one injecting passage supplies the pressurized gas from the at least one canister to an ullage space within the at least one storage container.
